(19) United States
(12) Patent Application Publication
(10) Pub. No.: US 2024/0368387 A1
(43) Pub. Date: Nov. 7, 2024

(54) Wet Adhesion of Storage-Stable Polychloroprene-Based Spray Adhesives

(71) Applicant: Covestro Deutschland AG, Leverkusen (DE)

(72) Inventors: Peter Kueker, Leverkusen (DE); Juergen Kempkes, Köln (DE); Udo Wipperfuerth, Köln (DE); Christoph Thiebes, Köln (DE); Ruediger Musch, Bergisch Gladbach (DE)

(21) Appl. No.: 18/683,874

(22) PCT Filed: Aug. 11, 2022
(86) PCT No.: PCT/EP2022/072604

§ 371 Date: Feb. 15, 2024

(30) Foreign Application Priority Data
Aug. 16, 2021 (EP) 21191434.6

(51) Int. Cl. C08L 11/02; C08J 5/12; C08K 3/36; C08K 9/02; C08L 25/14; C09J 11/04; C09J 111/02

(52) U.S. Cl. CPC C08L 11/02; C08J 5/127; C08K 3/36; C08K 9/02; C08L 25/14; C09J 11/04; C09J 111/02; C08K 2201/005; C08K 2201/011; C08K 2201/014; C08L 2201/50; C09J 2400/10; C09J 2411/00

(57) ABSTRACT

An aqueous dispersion contains at least polychlorprene, a component selected from the group consisting of dilute silicic acid sol, a modified silica sol and mixtures thereof, a acrylic acid or a copolymer containing acrylic acid ester and optionally further additives. The aqueous dispersion has a pH of 9.7 to 10.8. The disclosure also relates to a method for preparing the aqueous dispersion, to an adhesive composition at least containing the aqueous dispersion, to the use of the dispersion for preparing adhesive compositions, to the use of the dispersion for adhesively bonding foam substrates according to the spray coagulation method, to an adhesive composite containing at least one substrate and/or sheet material adhesively bonded using the aqueous dispersion, and to a method for producing a composite material. At least two joining parts of the composite material are adhesively bonded using the aqueous dispersion.

### CROSS-REFERENCE TO RELATED APPLICATIONS

This application is the United States national phase of International Application No. PCT/EP2022/072604 filed Aug. 11, 2022, and claims priority to European Patent Application No. 21191434.6 filed Aug. 16, 2021, the disclosures of which are hereby incorporated by reference in their entireties.

### BACKGROUND

### Technical Field

The present invention relates to an aqueous dispersion at least containing at least one polychloroprene, at least one component selected from the group consisting of fresh sol, a modified silica sol, and mixtures thereof, at least one copolymer containing acrylic acid or an acrylic ester, and optionally further additives, wherein the aqueous dispersion has a pH of 9.7 to 10.8, to a process for preparing the aqueous dispersion, to an adhesive composition at least containing the aqueous dispersion, to the use of the dispersion for the production of adhesive compositions, to the use of the dispersion for the adhesive bonding of foam substrates by the spray coagulation process, to an adhesive composite containing at least one substrate and/or sheetlike structure adhesively bonded using the aqueous dispersion, and to a method for producing a composite material, wherein at least two adherends of the composite material are adhesively bonded using the aqueous dispersions.

### Description of Related Art

Sprayable contact adhesives based on polychloroprene dispersions are known per se to those skilled in the art and are used in various areas, especially for foam adhesive bonding in the mattress and furniture sectors. In particular, the following two processes are known:

In the 2K (two-component) process, adhesive formulation and aqueous coagulant are atomized simultaneously using a spray gun that has two nozzles. Both mixtures meet in the spray jet and coagulate there and/or on the substrate surface, see in this respect Katsuyuki Hara, Institute of Technology, Osaka, Japan, “Two part spray mixing water borne adhesive” World adhesive congress, Munich, Jun. 8 to 10, 1988. However, this process is prone to failure and complex, since both components must be constantly atomized in a defined mixing ratio.

In the 1K (one-component) process, an adhesive formulation with limited shear stability is sprayed through a spray gun with a nozzle. It should be ensured that the formulation is storage-stable and the viscosity does not change during storage. Aqueous 1K formulations can contain organic solvents for producing wet tack in the adhesive dispersion, see for example EP 0 814 139 A1 or DE 3 028 693 A1. However, due to ecological, economic, occupational safety and hygiene reasons, there is a growing need for solvent-free adhesive formulations.

A prerequisite for the use of sprayable polychloroprene dispersions as 1K adhesives is the lowering of the pH to less than 9.5, where the effect of wet adhesive bonding increases as the pH falls, but at the same time the instability of the formulations, particularly during storage and transport, also increases.

The documents EP 0 624 634 A1 and EP 0 470 928 A1 describe solvent-free, aqueous 1K formulations for the elastic adhesive bonding of substrate surfaces which during adhesive bonding have higher initial strengths because they contain a mixture of acrylic ester copolymers and polychloroprene. Additional destabilization of the aqueous polymer dispersion is possible by lowering the pH. The pH is adjusted in such a way that the latex forms a film directly after application to the substrate and can be adhesively bonded. This is done, for example, by adding weak acids, for example boric acid, hydrogencarbonate, acetic acid, glycine, other amino acids, tartaric acid, citric acid, or the alkali metal and alkaline earth metal salts thereof. In the case of these metastable dispersions, the reduced storability, in particular the tendency to coagulate during transport or in the event of temperature fluctuations, is a disadvantage.

Another option for producing 1K spray adhesives based on polychloroprene is described in the document DE 10 2009 020497 A1. Phthalates are added to the corresponding formulations. Many of these phthalates are harmful to health and are listed as substances that require registration, for example the compound with the CAS number 84-69-5.

US 2003/221778 describes the use of silica sol in polychloroprene dispersions with the aim of increasing the final strengths of the adhesive bonds in the highly viscous formulations. However, this is only possible by adding zinc oxide. However, zinc oxide in particular is of toxicological concern.

### SUMMARY

The object of the present invention is therefore to provide a polychloroprene-based aqueous dispersion or 1K adhesive formulation that can be used in a 1K process and has advantageous properties, in particular high initial strength, i.e. wet strength, of the adhesive bond, good storage stability of the adhesive formulation and overall high adhesive performance. Furthermore, the 1K adhesive formulations provided are to have outstanding pH stability and excellent aging stability, despite dispensing with potentially environmentally hazardous acid scavengers such as ZnO.

These objects are achieved according to the invention by an aqueous dispersion at least containing
a) at least one polychloroprene,
b) at least one component selected from the group consisting of fresh sol, a modified silica sol, and mixtures thereof,
c) at least one copolymer containing acrylic acid or an acrylic ester, and
d) optionally further additives,
   wherein the aqueous dispersion has a pH of 9.7 to 10.8.

### BRIEF DESCRIPTION OF THE DRAWING

FIG. 1 is a schematic drawing of a device for determining initial strength of a test material.

### DETAILED DESCRIPTION

The essential and optional components of the aqueous dispersion according to the invention are described in detail hereinafter.

As component a), the aqueous dispersion according to the invention contains at least one polychloroprene.

Polychloroprene is known per se to those skilled in the art. The polychloroprene present in the dispersion according to the invention can be prepared by processes known per se to those skilled in the art, for example by emulsion polymerization in alkaline, aqueous medium, described for example in “Ullmanns Encyclopädie der technischen Chemie [Ullmann's Encyclopedia of Industrial Chemistry]”, Volume 9, p. 366, Verlag Urban and Schwarzenberg, Munich-Berlin 1957, “Encyclopedia of Polymer Science and Technology”, Vol. 20 3, pp. 705 to 730, John Wiley, New York 1965 or “Methoden der Organischen Chemie [Methods of Organic Chemistry]” (Houben-Weyl) XIV/1, pages 738 f. Georg Thieme Verlag Stuttgart 1961.

According to the invention, at least one polychloroprene homopolymer or at least one polychloroprene copolymer can be used as component a) of the dispersion according to the invention. Suitable polychloroprene copolymers are obtained, for example, by polymerizing chloroprene and 0.1% to 20% by weight of at least one ethylenically unsaturated monomer that is copolymerizable with chloroprene, this preferably being done in an alkaline medium.

Suitable copolymerizable monomers are described, for example, in “Methoden der Organischen Chemie [Methods of Organic Chemistry]” (Houben-Weyl) XIV/1, 738 f. Georg Thieme Verlag Stuttgart 1961. Compounds having 3 to 12 carbon atoms and 1 or 2 copolymerizable C-C double bonds per molecule are preferred. Examples of preferred copolymerizable monomers are selected from the group consisting of 2,3-dichlorobutadiene, 1-chlorobutadiene, and mixtures thereof. Sulfur can moreover also be used as inorganic copolymerizable monomer in the form of a dispersion.

In the aqueous dispersion according to the invention, the at least one polychloroprene is present preferably in particles having a mean particle size of 60 to 220 nm, determined by the method according to DIN ISO 13321-2004.

The at least one polychloroprene present according to the invention preferably has a gel content (toluene-insoluble fraction) of 5% to 30% by weight.

The at least one polychloroprene present according to the invention more preferably has a number-average molecular weight of the toluene-insoluble fraction of 200 000 to 500 000 g/mol.

The at least one polychloroprene present according to the invention more preferably has a molecular weight distribution (Mw/Mn) of 2.0 to 4.0.

The properties of the polychloroprene mentioned above, in particular molecular weight and molecular weight distribution, can be determined by methods known to those skilled in the art, for example solvent gradient chromatography, gel chromatography and/or ultracentrifuge experiments.

The at least one polychloroprene which according to the invention is used as component a) is preferably used as an aqueous polychloroprene dispersion. Suitable aqueous polychloroprene dispersions are produced for example by emulsion polymerization at 0 to 70° C., preferably 5 to 45° C., and at a pH of 10 to 14, preferably 11 to 13. The activation, i.e. the free-radical initiation of the reaction, is performed by the customary activators or activator systems. The polychloroprene dispersion used according to the invention can be prepared either continuously or batchwise, with continuous polymerization being preferred.

Polychloroprene dispersions that are particularly suitable according to the invention are prepared by emulsion polymerization, in alkaline medium, of chloroprene and optionally an ethylenically unsaturated monomer that can be copolymerized with chloroprene, as disclosed, for example, in WO-A 02/24825, DE-A 30 02 734, U.S. Pat. No. 5,773,544 or WO 2009/027013 A. Particular preference is given to polychloroprene dispersions that are produced by continuous polymerization, as described, for example, in WO 02/24825 A, in particular example 2, and DE 3 002 734, in particular example 6, where the chain transfer agent content can be varied from 0.01% to 0.3% by weight. Suitable chain transfer agents are known per se to those skilled in the art, especially chain transfer agents such as for example mercaptans, for example described in DE 3 002 711 A and GB 1 048 235 A, or xanthogen disulfides.

In the aqueous dispersion preferably used according to the invention, the at least one polychloroprene is present preferably in particles having a mean particle size of 60 to 220 nm, determined in each case by the method according to DIN ISO 13321-2004. Furthermore, the aqueous dispersion preferably used according to the invention preferably has a residual monomer content of less than 50 ppm, determined by methods known to those skilled in the art, in particular quantitative determination of chloroprene from polychloroprene latex using headspace GC and standard addition methods (conditions head space oven 70 C. Restek/Stabilwax-MS column (L: 30 m, ID: 0.25 mm, FT: 0.25 μm), column oven: 70->180 C 10K/min, FID Detector).

To adjust the molecular weight or molecular weight distribution of the polychloroprene used according to the invention, it is possible to use chain transfer agents known to those skilled in the art, examples being mercaptans, described for example in DE 3 002 711 A and GB 1 048 235 A, or xanthogen disulfides, described for example in DE 1186215 A and DE 2156453 A.

The polymerization for preparing the polychloroprene is generally terminated at a monomer conversion of 50% to 95%, preferably 60% to 80%, where the inhibitor used can for example be phenothiazine, tert- butylpyrocatechol and/or diethylhydroxylamine. On completion of the polymerization, the remaining chloroprene monomer is preferably removed down to a residual concentration of less than 50 ppm, for example by steam distillation and/or column degassing. The removal is effected, for example, as described by W. Obrecht in Houben-Weyl: Methoden der organischen Chemie [Methods of organic chemistry] vol. 20 part 3 Makromolekulare Stoffe [Macromolecular Substances], (1987) p. 852 ff.

The polychloroprene, in particular directly after the preparation of the intermediate product, i.e. the thin latex, immediately after degassing, i.e. after separation from the residual monomers, is stored preferably at a temperature of 50 to 110° C., preferably 60 to 100° C., particularly preferably 70 to 90° C., during which the fraction insoluble in organic solvents (gel fraction) rises by at least 10% by weight to 1% to 60% by weight, preferably to 5% to 30% by weight, particularly preferably to 10% to 20% by weight.

After the aqueous polychloroprene dispersion has been prepared, the solids content thereof can optionally be increased by a creaming process known per se to those skilled in the art. This creaming is effected, for example, by adding alginates, as described in “Neoprene Latices, John C. Carl, E.I. Du Pont 1964, p. 13”.

Preferably, according to the invention, the at least one polychloroprene is used as an aqueous dispersion with a solids content of 29% to 58% by weight, preferably 50% to 58% by weight, particularly preferably 55% to 57% by weight, determined in each case in accordance with DIN EN ISO 3251-2019-09—(Determination of the content of non-volatile fractions). Corresponding polychloroprene dispersions are commercially available, for example, under the trade name Dispercoll® C from Covestro Deutschland AG.

As component b), the dispersion according to the invention contains at least one component selected from the group consisting of fresh sol, a modified silica sol, and mixtures thereof.

In the context of the present invention, the term “fresh sol” is understood as meaning a dilute silica solution Si(OH)₄. This is generally not stable in the free state and is therefore preferably prepared in situ from various precursors, for example as described in U.S. Pat. Nos. 2,244,325 and 3,468,813.

Examples of starting materials for fresh sol that are used on an industrial scale include industrial waterglasses such as sodium hydroxide waterglasses or potassium hydroxide waterglasses.

For the preparation of the fresh sol used according to the invention, an alkali metal-free SiO₂ solution is preferably required, which can be produced, for example, by removing the alkali metal cations from waterglass, for example by treating a dilute waterglass solution with cation exchange resins in the H⁺ form. Examples of cation exchange resins suitable for this are Lewatit® types from Lanxess AG. To this end, preference is given to using waterglass solutions having an SiO₂ content of below 10% by weight. The fresh sol thus obtained has a solids concentration of preferably 2% to 8% by weight, particularly preferably 3.5% to 6.5% by weight.

The present invention therefore preferably relates to the aqueous dispersion according to the invention, wherein the fresh sol is used as an aqueous silica solution with a solids content of 1% to 10% by weight, preferably 2% to 8% by weight, particularly preferably 3.5% to 6.5% by weight.

The present invention furthermore also relates to the dispersion according to the invention, wherein the pH of the fresh sol used is 1.0 to 3.5, preferably 1.5 to 3.0, particularly preferably 1.7 to 2.9.

The present invention further relates preferably to the aqueous dispersion according to the invention containing at least one fresh sol in a concentration of 0.5% to 15% by weight, preferably 3% to 12% by weight, based in each case on the total weight of the non-volatile fractions of the dispersion.

In a further embodiment, the aqueous dispersion according to the invention can contain at least one modified silica sol as component b).

Aqueous dispersions of silicon dioxide, so-called silica sols, have long been known. Silica sols are colloidal solutions of amorphous silicon dioxide in water. The silicon dioxide is preferably present here in the form of spherical particles having surface hydroxylation. The particle diameter of the colloid particles is generally 1 to 200 nm, in each case an approximate mean value calculated from specific surface area. The specific surface area is determined in accordance with DIN 66131-1993-07. The BET specific surface area correlating to the particle size and determined by the method of G.N. Sears, Analytical Chemistry Vol. 28, No. 12, pages 1981 to 1983 December 1956, is preferably 15 to 2000 m²/g. The surface of the SiO₂ particles preferably has a charge that is balanced by a corresponding counterion that results in stabilization of the colloidal solution. The alkali-stabilized silica sols have for example a pH of 7 to 11.5 and contain as alkalizing agents for example small amounts of Na₂O, K₂O, Li₂O, ammonia, organic nitrogen bases, tetraalkylammonium hydroxides or alkali metal or ammonium aluminates. Silica sols may also be present in weakly acidic form as semistable colloidal solutions.

According to the invention, at least one modified silica sol is used. For example, it is possible to obtain modified, especially surface-modified, silica sols by coating the surface with metal-containing compounds, especially aluminum-containing compounds, for example Al₂(OH)₅Cl.

According to the invention, therefore, preference is given to using at least one surface-modified silica as component b).

According to the invention, particular preference is given to using as component b) silica sols which are obtained by surface modification of the SiO₂ particles by adding aluminate ions, e.g. [Al(OH)₄]. The use, which is preferred according to the invention, of silica sols modified on the surface with aluminate ions brings about high pH stability and thereby increases the gelling stability.

The at least one modified silica sol preferably has a primary particle size of 1 to 100 nm, preferably 2 to 40 nm, determined in each case in accordance with DIN 66131-1993-07.

The present invention therefore relates in particular to the aqueous dispersion according to the invention, wherein the modified silica sol has a primary particle size of 1 to 100 nm, preferably 2 to 40 nm.

Preferably, according to the invention, the modified silica sol is an anionic, aluminate-modified silica sol.

The present invention therefore preferably relates to the aqueous dispersion according to the invention, wherein the modified silica sol is an anionic, aluminate-modified silica sol.

More preferably, the component b) used according to the invention is preferably at least one modified silica sol in which the SiO₂ particles present are in the form of discrete, uncrosslinked primary particles and more preferably have hydroxyl groups on the particle surface.

If the component b) used according to the invention is at least one modified silica sol, this is preferably present to an extent of 0.25% to 10% by weight, particularly preferably 1.5% to 10% by weight, based in each case on the total weight of the non-volatile fractions of the dispersion.

As component b), it is also possible to use a mixture of at least one fresh sol and at least one modified silica sol in the aqueous dispersion according to the invention. The statements already made with respect to the at least one fresh sol and the at least one modified silica sol also apply to this mixture.

Preferably, in the mixture of at least one fresh sol and at least one modified silica sol, the at least one fresh sol is present in an amount of 0.5% to 15% by weight, particularly preferably 3% to 12% by weight, and the at least one modified silica sol is present in an amount of 0.25% to 10% by weight, particularly preferably 1.5% to 10% by weight, based in each case on the mixture of at least one fresh sol and at least one modified silica sol, wherein the sum total of the amounts of at least one fresh sol and at least one modified silica sol is 100% by weight in each case.

A corresponding mixture can generally be prepared by methods known to those skilled in the art, for example by mixing the two components in the respective amounts.

As component c), the aqueous dispersion according to the invention optionally contains at least one copolymer containing acrylic acid or an acrylic ester.

As component c), preference according to the invention is given to using copolymers containing at least acrylic acid, at least one acrylic ester and/or at least one further monomer, for example styrene.

As component c), particular preference according to the invention is given to using acrylic ester copolymers containing at least one acrylic ester and at least one further monomer, especially styrene.

Suitable acrylic ester copolymers, in particular styrene-acrylic ester copolymers, in particular aqueous dispersions thereof, and processes for the preparation thereof are known per se to those skilled in the art. They are described, for example, in Irving Skeist's Handbook of Adhesives, 2nd Edition, 1977, page 528 ff “Acrylic adhesives and sealants, K. Eisenträger, W. Druschke”.

The acrylic ester-styrene copolymers used with preference in accordance with the invention preferably contain 50% to 80% by weight of styrene and 20% to 50% by weight of one or more acrylic esters, preferably of alcohols having 1 to 18 carbon atoms, in particular selected from the group consisting of methyl acrylate, ethyl acrylate, propyl acrylate, butyl acrylate, 2-ethylhexyl acrylate, and mixtures thereof, optionally in a mixture with methacrylic esters such as methyl methacrylate, and 0% to 10% by weight of one or more ethylenically unsaturated functional comonomers, where the amounts indicated in % by weight add up to 100% by weight in each case.

As component b), particular preference according to the invention is given to styrene-acrylic ester copolymers having low viscosities, especially in the region <400 mPa·s, measured at 250 l/s, 23° C. according to DIN EN ISO 3219-1994, and more preferably with a Tg<0° C. These preferred styrene-acrylic esters have the advantage of increasing the adhesive strength in the formulations according to the invention.

The at least one copolymer containing acrylic acid or an acrylic ester is present in the aqueous dispersion according to the invention preferably in an amount of 12% to 35% by weight, particularly preferably 15% to 30% by weight, very particularly preferably 18% to 28% by weight, based in each case on the non-volatile fractions of the aqueous dispersion.

Styrene-acrylic ester copolymers according to the present invention which are particularly suitable as component b) are commercially available, for example under the trade name Acronal® from BASF Deutschland AG.

The aqueous dispersion according to the invention optionally contains further additives as optional component d).

If further additives are present in the aqueous dispersion according to the invention, then they are present, for example, in an amount of 0.1% to 30% by weight, based on the non-volatile fractions of the aqueous dispersion.

Suitable additives for adhesive formulations are known per se to those skilled in the art and are selected, for example, from the group consisting of wetting agents, tackifier resins, pigments, flame retardants, antioxidants, dispersing agents, emulsifiers, adhesion promoters, defoamers, aging stabilizers, oxidation stabilizers, UV stabilizers, and mixtures thereof.

Suitable wetting agents are, for example, polyphosphates such as sodium hexametaphosphate, naphthalenesulfonic acid, ammonium or sodium polyacrylic acid salts. Likewise suitable are salts of polyacrylic acids, especially sodium salts of polyacrylic acids, commercially available, for example, under the Dispex N40 trade name from BASF SE. Preferably, according to the invention, wetting agents are used in an amount of 0.2% to 0.6% by weight, based on the non-volatile fractions of the aqueous dispersion.

It is also possible to add tackifying resins, for example unmodified or modified natural resins such as rosin esters, hydrocarbon resins or synthetic resins, such as phthalate resins, to the aqueous dispersion of the invention in dispersed form; in this respect see, for example, “Klebharze” [Tackifying Resins] R. Jordan, R. Hinterwaldner, pages 75 to 115, Hinterwaldner Verlag Munich 1994. Preference is given to alkylphenol resin and terpene phenolic resin dispersions having softening points greater than 70° C., particularly preferably greater than 110° C.

Examples of suitable ageing stabilizers, oxidation stabilizers and/or UV stabilizers are those based on oligofunctional secondary aromatic amines or oligofunctional substituted phenols, such as products of the type 6-PPD (N-(1,3-dimethylbutyl)-N′-phenyl-p-phenylenediamine), for example Vulkanox® from Lanxess Deutschland GmbH, DTPD, DDA, BPH, BHT or compounds based on HALS (hindered amine light stabilizers), benzotriazoles, oxalanilides, hydroxybenzophenones and/or hydroxyphenyl-s-triazines. Preference is given typically to introducing corresponding ageing stabilizers, oxidation stabilizers and/or UV stabilizers in emulsified form as an aqueous dispersion. According to the invention, ageing stabilizers, oxidation stabilizers and/or UV stabilizers can be present in an amount of 0.1 to 5 parts by weight, preferably 1 to 3 parts by weight, particularly preferably 1.5 to 2.5 parts by weight, based in each case on the amount of polychloroprene present.

The present invention therefore preferably relates to the dispersion according to the invention, wherein
a) the at least one polychloroprene is present to an extent of 65% to 94% by weight, preferably 70% to 90% by weight,
b) the at least one fresh sol and at least one modified silica sol, the at least one fresh sol is present in an amount of 0.5% to 15% by weight, particularly preferably 3% to 12% by weight, and the at least one modified silica sol is present in an amount of 0.25% to 10% by weight, particularly preferably 1.5% to 10% by weight, and
c) at least one copolymer containing acrylic acid or an acrylic ester is present to an extent of 12% to 35% by weight, preferably 13% to 30% by weight, particularly preferably 14% to 28% by weight,
   based in each case on the total weight of the non-volatile fractions of the dispersion, and the sum of the components present is 100% by weight in each case.

If in the dispersion according to the invention the component b) used is at least one fresh sol, this is preferably present in an amount of 0.5% to 15.0% by weight, particularly preferably 3% to 12% by weight, based in each case on the total weight of the non-volatile fractions of the dispersion, and the sum of the components present is 100% by weight in each case.

If in the dispersion according to the invention the component b) used is at least one modified silica sol, this is preferably present in an amount of 0.25% to 10.0% by weight, particularly preferably 1.5% to 10.0% by weight, based in each case on the total weight of the non-volatile fractions of the dispersion, and the sum of the components present is 100% by weight in each case.

If in the dispersion according to the invention the component b) used is a mixture of at least one fresh sol and at least one modified silica sol, this is preferably present in an amount of 0.5% to 20% by weight, particularly preferably 3% to 15% by weight, based in each case on the total weight of the non-volatile fractions of the dispersion, and the sum of the components present is 100% by weight in each case.

The aqueous dispersion according to the invention has a pH of 9.7 to 10.8, preferably of 10.0 to 10.5.

The aqueous dispersion according to the invention preferably has a viscosity of 500 to 7000 mPa·s, particularly preferably 1500 to 6000 mPa·s, determined in each case according to DIN EN ISO 2555-2018-09 using a Brookfield rotary viscometer.

The present invention also relates to a process for preparing the aqueous dispersion according to the invention, wherein a) at least one polychloroprene is provided as an aqueous dispersion, and b) is mixed with at least one component selected from the group consisting of fresh sol, a modified silica sol and mixtures thereof, c) at least one copolymer containing acrylic acid or an acrylic ester, and d) optionally at least one further additive, the aqueous dispersion having a pH of 9.7 to 10.8.

The present invention preferably relates to the process for preparing the aqueous dispersion according to the invention, comprising at least the steps of:
(A) providing components a), b) and c) in the appropriate amounts, and
(B) mixing the components provided in step (A) to obtain the aqueous dispersion.

To prepare the aqueous dispersions according to the invention, the proportions of the individual components are chosen such that the resulting dispersion according to the invention contains components a), b) and c) in the amounts indicated above.

In a preferred embodiment of the present invention, the aqueous dispersion according to the invention is prepared by mixing a dispersion containing at least one polychloroprene with at least one copolymer containing acrylic acid or an acrylic ester and with at least one fresh sol and/or at least one modified silica sol, and optionally with further additives, in particular the adhesive auxiliaries and additions mentioned above.

Further preference is given to using the at least one polychloroprene as aqueous dispersion, the at least one modified silica sol as aqueous dispersion, the adhesive auxiliaries and additions as aqueous dispersion, and the at least one acrylic ester copolymer that is predispersed with fresh sol in the aqueous dispersion.

In a further preferred embodiment of the present invention, the aqueous dispersion according to the invention is prepared by providing a dispersion containing at least one polychloroprene and adding a mixture of at least one copolymer containing acrylic acid or an acrylic ester and of at least one fresh sol. Further additives, in particular the adhesive auxiliaries and additions mentioned above, can then optionally be added.

The present invention also relates to an adhesive composition, in particular a 1K (one-component) adhesive composition, at least containing the aqueous dispersion according to the invention.

The present invention also relates to the use of the aqueous dispersion according to the invention for the production of adhesive compositions, especially of 1K (one-component) adhesive compositions.

According to the invention, the adhesive composition is preferably used in an application rate of 130 to 150 g/m² wet.

The present invention also relates to the use of the aqueous dispersion according to the invention for the adhesive bonding of foam substrates by the spray coagulation process.

The present invention also relates to an adhesive composite containing at least one substrate and/or sheetlike structure adhesively bonded using an aqueous dispersion according to the invention.

The present invention also relates to the use of the aqueous dispersion according to the invention for the adhesive bonding of wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case to one another and/or to porous substrates, preferably with a density of less than 1 kg/liter, in particular for the adhesive bonding of foams in mattress, furniture and/or upholstery adhesive bonding.

The present invention also relates to a method for producing a composite material, wherein at least two adherends of the composite material are adhesively bonded using the aqueous dispersion according to the invention.

The aqueous dispersion according to the invention can generally be applied to the substrates using all common forms of application, in particular by painting, rolling, atomizing and/or spraying, in particular by spray application, brush application or roller application. The adhesives according to the invention are preferably applied by means of spray application.

Examples of substrates that are suitable according to the invention are wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case to one another and/or to porous substrates, preferably with a density of less than 1 kg/liter.

In particular the present invention relates to the method according to the invention for producing a wet-on-wet adhesive bond, wherein an adhesive composition according to the invention and containing the aqueous dispersion according to the invention is applied to a foam substrate for example by means of spray application, roller application or brush application, and after a flash-off time for example of <5 min, preferably <2 min, particularly preferably ≤1 min, a wet bond is produced prior to film formation.

### EXAMPLES

The present invention is elucidated in more detail by means of the examples that follow:

Table 1 shows the ingredients used in the examples according to the invention and/or comparative examples:

TABLE 1
Components used

| Type | Trade name | Properties | Form used |
|---|---|---|---|
| Poly- | Dispercoll ® | 2-chlorobutadiene | aqueous |
| chloroprene | C 84 | polymer with | dispersion, |
| | | a high degree | 55% by |
| | | of crystallization | weight solids |
| | | (Shore A | |
| | | hardness >70) | |
| Acrylic ester- | Acronal ® | copolymer of styrene | aqueous |
| styrene | 5400 | and acrylic ester | dispersion, |
| copolymer | | | 57% by |
| | | | weight solids |
| Silica sol | Levasil ® | amorphous silicon | aqueous |
| | CS 15-340 P | dioxide, aluminate- | dispersion, |
| | | modified, mean particle | 15% by |
| | | size approx. 15 nm | weight solids |
| Fresh sol | Levasil ® | silica and | aqueous solution, |
| | CS 6-3P | oligosilicic acid | 6% by |
| | | | weight solids |
| pH regulator | glycine | aminoacetic acid | solid |

### Methods/Measurement Methods

The following methods/measurement methods were employed in the examples according to the invention and/or the comparative examples.

### Spray Method

The adhesive formulation was applied to the test material by means of a spray gun (Walther PILOT PREMIUM ND, p=approx. 1.5 bar, spray nozzle with a diameter of approx. 1.0 mm).

### Coating With a Brush

The adhesive formulation was applied to both sides of the PU foam body by means of a brush.

### Test Specimens

PU foam bodies from stn/schaumstoff-technik-Nürnberg GmbH were used. Type ST 5540, dimensions of the test specimens: 101 mm×49 mm×30 mm, material basis PUR, color white, gross weight 40 kg/m², net bulk density 38 kg/m³ according to ISO-845:2009-10, compression hardness at 40% 5.5 (kPa) according to DIN EN ISO 3386:2015-10, tensile strength >120 kPa according to DIN EN ISO 1798:2008-04, elongation at break >110% according to ISO-1798:2008-04, compression set <4 according to DIN EN ISO-1856:2018-11 (50%/70° C./22 h).

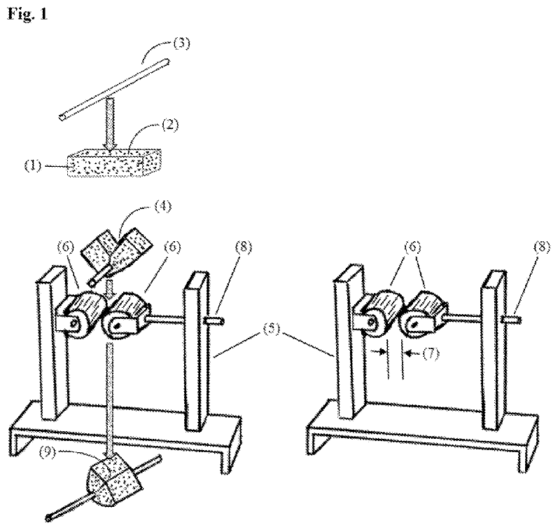

### Determination of Initial Strength (see also FIG. 1):

The test specimens mentioned above were used as test material. For assessment of the initial strength, immediately after application of the adhesive to the upper side (2) of the foam bodies (1) by means of the spray coagulation process (application rate 130 to 150 g/m² wet), the test specimens were folded (4) in the middle with a wooden rod (3) (7×7 mm square) and fed by means of the test apparatus (5) through 2 steel rollers (6) (diameter 40 mm each, length 64 mm each) the tangential spacing (7) of which had been set beforehand to 10 mm using a threaded spindle (8).

### Assessment of the Initial Strength

An immediate initial strength was present when the test specimen or the bond seam (9) no longer came undone despite the restoring forces present in the test specimen.

For better quantification of the initial strength, this was evaluated as follows:
“1”: The stress was immediately withstood after drawing the test specimen once through the gap between the two rollers. If the foam body was pulled apart from both sides after 120 s and there was material tearing, or could be opened up again only with a high expenditure of force, then the initial strength was rated “1”.
“2”: The stress was immediately withstood after drawing the test specimen once through the gap between the two rollers. If the foam body could be opened up again after 120 s without high expenditure of force by pulling it apart from both sides, then the initial strength was rated “2”.
“3”: The test specimen came open after drawing the test specimen once through the gap between the two rollers. Only through repetition or upon subsequent manual pressure (1× pressure application for approx. 1 sec.) did the test specimen remained closed, rating “3”.
“4”: The stress was not withstood even after repeated application of pressure (by roller and by hand), rating “4”.

### Determination of Viscosity

The viscosity of the dispersions was determined using a Brookfield viscometer in accordance with DIN ISO 2555:2018-09. To this end, the spindle was carefully immersed into the dispersion to be measured, as far as possible without air bubble formation. To this end, the bottle containing the sample to be analyzed was placed on a lifting platform and first of all raised until the spindle was able to be secured to the drive shaft without the spindle body emerging from the dispersion. The lifting platform was raised further until the spindle was immersed in the sample up to the immersion groove on the spindle shaft. The motor was switched on. As soon as the LED display of the measured value had stabilized, the measured value was read off.

Depending on the viscosity range, the procedure was as follows:
Viscosity range <1000 mPa·s: measurement with spindle #2 at 60 rpm.
Viscosity range 1000 to 2500 mPa·s: measurement with spindle #2 at 12 rpm.
Viscosity range 2500 to 10 000 mPa·s: measurement with spindle #3 at 12 rpm.

### Determination of pH

A single-probe measurement electrode (Metrohm PH meter) was immersed in the dispersion or solution to be tested.

### Preparation of the Adhesive Formulations

To prepare a formulation, the polychloroprene dispersion was initially charged into a glass beaker. The fresh sol and/or the modified silica sol and, if required, the acrylic ester-styrene copolymer were then added in succession with stirring. Once all of the desired constituents have been mixed in, the pH can be adjusted, if necessary, by adding glycine powder until the target pH of the formulation has been reached.

TABLE 2
Long-term storage stability of the mixture of
polychloroprene and aluminate-mod. silica sol

| | Example No. | | | | | |
|---|---|---|---|---|---|---|
| | 1 | 2 | 3 | 4 | 5 | 6 |
| Dispercoll ® C 84 | 190 | 180 | 170 | 160 | 150 | 140 |
| Levasil ® CS 15-340 P | 10 | 20 | 30 | 40 | 50 | 60 |
| Viscosity [mPa · s] | 1240 | 3800 | 6500 | 13000 | 24000 | Paste |
| pH | 10.8 | 10.6 | 10.4 | 10.2 | 10.0 | 9.9 |
| Initial strength | 4 | 4 | 4 | 4 | 3 | 3 |
| After 7 months | | | | | | |
| Viscosity [mPa · s] | 1790 | 4600 | 6300 | 12600 | 20000 | Paste |
| pH | 10.2 | 9.9 | 9.7 | 9.4 | 9.4 | 9.3 |
| Initial strength | 4 | 4 | 3 | 1 | 1 | Not spreadable |

All reported data in % by weight unless otherwise stated. Application type: Brush
C Comparative

The mixture according to the invention of polychloroprene and the aluminate-modified silica sol has excellent storage stability. There was no demixing or coagulation in any of the batches. The pH values and the viscosities have hardly changed after a storage time of 7 months. Immediate wet adhesive bonding is only achieved at pH values below 9.5.

TABLE 3
Reduction of the pH of polychloroprene with fresh sol

| | Example No. | | | | | | | | | | |
|---|---|---|---|---|---|---|---|---|---|---|---|
| | 7 | 8 | 9 | 10 | 11 | 12 | 13 | 14 | 15 | 16 | C17 |
| Dispercoll ® C 84 | 190 | 180 | 170 | 160 | 150 | 140 | 130 | 120 | 100 | 784 | 784 |
| Levasil ® CS 6-3 P | 10 | 20 | 30 | 40 | 50 | 60 | 70 | 80 | 90 | 42 | 0 |
| Acronal ® 5400 | — | — | — | — | — | — | — | — | — | 216 | 216 |
| Glycine | — | — | — | — | — | — | — | — | — | 0 | 1.0 |
| Viscosity [mPa · s] | >100 | >100 | >100 | >100 | >100 | >100 | >100 | >100 | >100 | >100 | >100 |
| pH | 10.9 | 10.7 | 10.5 | 10.3 | 10.0 | 9.8 | 9.5 | 9.3 | 9.0 | 10.2 | 10.2 |
| Initial strength | 4 | 4 | 3 | 1 | 1 | 1 | 1 | 1 | 1 | 1 | 3 |
| After 1 month | | | | | | | | | | | |
| pH | 11.0 | 10.8 | 10.6 | 10.4 | 10.1 | 9.9 | 9.6 | 9.4 | 9.3 | 10.3 | 10.2 |
| Storage stability | 1) | 1) | 1) | 2) | 2) | 2) | 2) | 2) | 2) | 1) | 3) |

All reported data in % by weight unless otherwise stated. Application type: Brush
1) Low-viscosity
2) Gel formation
3) Coagulation

The use according to the invention of a fresh sol solution lowers the pH significantly, but without increasing the viscosity. Advantageously, immediate wet adhesive bonding could be observed even at pH values above 10.0. However, the polycondensation of the fresh sol solution, which occurred after the mixtures had been stored, became noticeable as adversely impacted.

In example C17, the addition of an acrylate to the formulation according to the prior art led to poorer wet adhesive bonding and rapid coagulation, whereas it had a stabilizing effect in the presence of the fresh sol (example 16, according to the invention).

TABLE 4
Stabilization of the polychloroprene - fresh sol mixture
according to the invention by means of acrylate

| | Example No. | | | | | | | | |
|---|---|---|---|---|---|---|---|---|---|
| | 18 | 19 | 20 | 21 | 22 | 23 | 24 | 25 | 26 |
| Dispercoll ® C 84, pH 12.6 | 392.2 | 392.2 | 392.2 | — | — | — | — | — | — |
| Dispercoll ® C 84, pH 10 | — | — | — | 392.2 | 392.2 | 392.2 | — | — | — |
| Dispercoll ® C 84, pH 9.5 | — | — | — | — | — | — | 392.2 | 392.2 | 392.2 |
| pH adjustment by means of | — | — | — | yes | yes | yes | yes | yes | yes |
| glycine | | | | | | | | | |
| Levasil ® CS 6-3 P | 5 | 10 | 15 | 5 | 10 | 15 | 5 | 10 | 15 |
| Acronal ® 5400 | 107.8 | 107.8 | 107.8 | 107.8 | 107.8 | 107.8 | 107.8 | 107.8 | 107.8 |
| Viscosity [mPa · s] | 284 | 230 | 180 | 125 | 160 | 220 | 128 | 154 | 194 |
| pH | 11.1 | 10.7 | 10.4 | 9.7 | 9.7 | 9.7 | 9.3 | 9.3 | 9.3 |
| After 5 months | | | | | | | | | |
| Viscosity [mPa · s] | 311 | 250 | 192 | 174 | 200 | 376 | 185 | 189 | 239 |
| pH | 10.1 | 10.2 | 10.3 | 9.4 | 9.4 | 9.4 | 9.2 | 9.1 | 9.1 |
| Initial strength | 1 | 1 | 2 | 1 | 1 | 1 | 1 | 1 | 1 |

All reported data in % by weight unless otherwise stated. Application type: Brush

In examples 18 to 26, a mixture according to the invention of polychloroprene, fresh sol and Acronal was prepared and stored. It was found that the fresh sol does not condense to give a polysilicic acid under these conditions, but rather interacts with other ionic groups on the Acronal and stabilizes itself, meaning that even after a storage period of 5 months, the viscosity, pH and initial strength have not changed.

In examples 18 to 20 according to the invention, as a result of the addition of acrylate and fresh sol, the polychloroprene dispersion can immediately be adhesively bonded even at a pH of <10.0, albeit with a low mixture viscosity.

TABLE 5
Preparation of high-viscosity, storage-stable polychloroprene-
based adhesive formulation according to the invention

| | Example No. | | | | | | | |
|---|---|---|---|---|---|---|---|---|
| | 27 | 28 | 29 | 30 * | 31 * | 32 * | 33 * | 34 * |
| Dispercoll ® | 190 | 180 | 170 | 190 | 180 | 170 | 190 | 180 |
| C | | | | | | | | |
| 84 | | | | | | | | |
| Acronal ® | — | — | — | 40 | 40 | 40 | 40 | 40 |
| 5400 | | | | | | | | |
| Levasil ® | 10 | 20 | 30 | 10 | 20 | 30 | — | — |
| CS 15- | | | | | | | | |
| 340 P | | | | | | | | |
| Levasil ® | — | — | — | — | — | — | 10 | 20 |
| CS 6-3 | | | | | | | | |
| P | | | | | | | | |
| Mixture | — | — | — | — | — | — | — | — |
| A (tab. | | | | | | | | |
| 6) | | | | | | | | |
| Mixture | — | — | — | — | — | — | — | — |
| B (tab. | | | | | | | | |
| 6) | | | | | | | | |
| Viscosity | 1100 | 2000 | 4200 | 341 | 1300 | 1900 | 8.0 | 140 |
| [mPa · s] | | | | | | | | |
| pH | 10.6 | 10.3 | 10.0 | 10.2 | 10.0 | 9.9 | 10.5 | 10.2 |
| Initial | 4 | 3 | 3 | 2 | 1 | 1 | 2 | 1 |
| strength | | | | | | | | |

| | Example No. | | | | | | | |
|---|---|---|---|---|---|---|---|---|
| | 35 * | 36 * | 37 * | 38 * | 39 * | 40 * | 41 * | 42 * |
| Dispercoll ® | 190 | 180 | 190 | 190 | 190 | 190 | 190 | 190 |
| C | | | | | | | | |
| 84 | | | | | | | | |
| Acronal ® | 40 | 40 | 30 | 30 | — | — | — | — |
| 5400 | | | | | | | | |
| Levasil ® | 10 | 20 | 15 | 10 | — | 10 | 15 | 10 |
| CS 15- | | | | | | | | |
| 340 P | | | | | | | | |
| Levasil ® | 10 | 20 | 10 | 10 | — | — | — | — |
| CS 6-3 | | | | | | | | |
| P | | | | | | | | |
| Mixture | — | — | — | — | 50 | 50 | — | — |
| A (tab. | | | | | | | | |
| 6) | | | | | | | | |
| Mixture | — | — | — | — | — | — | 40 | 40 |
| B (tab. | | | | | | | | |
| 6) | | | | | | | | |
| Viscosity | 400 | 3000 | 2000 | 400 | 110 | 1550 | 2020 | 1460 |
| [mPa · s] | | | | | | | | |
| pH | 10.1 | 9.9 | 10.2 | 10.3 | 10.2 | 10.2 | 10.1 | 10.2 |
| Initial | 1 | 1 | 1 | 1 | 1 | 1 | 1 | 1 |
| strength | | | | | | | | |

All reported data in % by weight unless otherwise stated. Application type: 1K spraying
* According to the invention

TABLE 6
Mixtures A and B

| Component | Solids content | Mixture A | Mixture B |
|---|---|---|---|
| Acronal ® 5400 | 57 | 416 | 400 |
| Levasil ® CS 6-3 P | 6 | 83 | 100 |

All data in % by weight unless otherwise stated.

1. An aqueous dispersion at least containing
a) at least one polychloroprene,
b) at least one component selected from the group consisting of fresh sol, a modified silica sol, and mixtures thereof,
c) at least one copolymer containing acrylic acid or an acrylic ester, and
d) optionally further additives,
wherein the aqueous dispersion has a pH of 9.7 to 10.8.

2. The dispersion as claimed in claim 1, wherein the at least one polychloroprene is present in particles having a mean particle size of 60 to 220 nm.

3. The dispersion as claimed in claim 1, wherein the fresh sol is used as an aqueous silica solution with a solids content of 1% to 10% by weight.

4. The dispersion as claimed in claim 1, wherein the modified silica sol is an anionic, aluminate-modified silica sol.

5. The dispersion as claimed in claim 1, wherein the at least one copolymer containing acrylic acid or an acrylic ester is at least one styrene-acrylic ester copolymer.

6. The dispersion as claimed in claim 1, wherein
a) the at least one polychloroprene is present to an extent of 65% to 94% by weight,
b) the at least one component selected from the group consisting of fresh sol and at least one modified silica sol, the at least one fresh sol is present in an amount of 0.5% to 15% by weight, and the at least one modified silica sol is present in an amount of 0.25% to 10% by weight, and
c) at least one copolymer containing acrylic acid or an acrylic ester is present to an extent of 12% to 35% by weight,
based in each case on the total weight of the non-volatile fractions of the dispersion, and the sum of the components present is 100% by weight in each case.

7. The dispersion as claimed in claim 1, wherein the dispersion has a viscosity of 500 to 7000 mPa·s, determined in each case according to DIN ISO 2555:2018-09 using a Brookfield rotary viscometer.

8. A process for preparing the aqueous dispersion as claim 1, wherein at least one polychloroprene is provided as an aqueous dispersion, and is mixed with at least one component selected from the group consisting of fresh sol, a modified silica sol and mixtures thereof, at least one copolymer containing acrylic acid or an acrylic ester, and optionally at least one further additive, the aqueous dispersion having a pH of 9.7 to 10.8.

9. An adhesive composition at least containing the dispersion as claimed in claim 1.

10. A method for producing adhesive compositions comprising providing the dispersion as claimed in claim 1.

11. A method for adhesive bonding of foam substrates by a spray coagulation process comprising providing the dispersion as claimed in claim 1.

12. An adhesive composite containing at least one substrate and/or sheetlike structure adhesively bonded using an aqueous dispersion as claimed in claim 1.

13. A method for the adhesive bonding of wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case to one another and/or to porous substrates comprising providing the aqueous dispersion as claimed in claim 1.

14. A method for producing a composite material, wherein at least two adherends of the composite material are adhesively bonded using the aqueous dispersion as claimed in claim 1.

15. The method as claimed in claim 13, wherein the density of the porous substrate is less than 1 kg/liter.

16. The method as claimed in claim 13, wherein a foam of at least one of a mattress, furniture, upholstery, or some combination thereof is adhesively bonded.
